(19) United States
(12) Patent Application Publication
(10) Pub. No.: US 2011/0206858 A1
(43) Pub. Date: Aug. 25, 2011

(54) UV CURABLE PUTTY COMPOSITIONS

(75) Inventors: Helmut Loeffler, Hennef (DE); Carmen Flosbach, Wuppertal (DE)

(73) Assignee: E.I. DU PONT DE NEMOURS AND COMPANY

(21) Appl. No.: 12/377,902

(22) PCT Filed: Aug. 8, 2007
(86) PCT No.: PCT/US07/17672

§ 371 Date: Feb. 18, 2009

Related U.S. Application Data
(60) Provisional application No. 60/838,713, filed on Aug. 18, 2006.

(51) Int. Cl. C08F 2/50; C09D 4/00; C09D 1/00; C08F 2/54

(52) U.S. Cl. 427/496; 524/855; 524/786; 524/791; 427/508

(57) ABSTRACT

The invention is directed to putty compositions curable by means of high energy radiation, comprising A) at least one compound capable of free-radical polymerization having at least one olefinic unsaturated group and B) at least one filler, the at least one filler or a mixture of fillers having a particle size distribution such that at most 8% by volume of the filler particles in relation to the total volume of fillers have a particle size of less than or equal to 1.9 μm and can be used particularly in repair coating vehicle bodies and parts thereof.

### FIELD OF THE INVENTION

The invention relates to a putty composition curable by means of high energy radiation and a process for multilayer coating, wherein the putty composition and at least one further coating composition are applied to the substrate. The putty composition and process for multilayer coating can particularly be used in the field of repair coating vehicle bodies and parts thereof.

### DESCRIPTION OF RELATED ART

It is known to use coating compositions curable by means of high energy radiation, particularly by means of UV (ultraviolet) radiation in automotive coating, particularly in automotive repair coating. It is likewise known in the context of automotive coating and automotive repair coating to produce the various layers of a multilayer structure, such as, putty, primer, primer surfacer, base coat and/or clear coat layer, from coating compositions curable by means of UV radiation.

Although UV curable systems indisputably have advantageous properties, known putty compositions curable by means of UV radiation still exhibit several disadvantages.

Because of the very high film thicknesses at which putty compositions are conventionally applied, for example film thicknesses of about 1-2 mm, and because of the very high proportion of filler in putty compositions, for example 50-80% by weight in relation to the total putty composition, it is problematic to achieve proper and complete curing of the thick putty layers when curing is performed using UV radiation. The UV radiation required for the curing procedure does not penetrate sufficiently deeply into the film at the required intensity. Insufficient curing in turn has a negative effect on, for example, adhesion to the substrate, the hardness of the coating and the sandability.

Attempts have already been made to improve curing in relatively thick films, for example by incorporating fillers with a high level of light transmission such as glass balls, or UV-transparent or UV-absorbing substances such as organic or inorganic pigments of a particular colour.

WO 97/33928 describes for example photocurable one-component putty compositions for repairing sheet metal, which can be cured by visible light. The putty composition comprises 33.3 to 73.5% by weight of a bisphenol A type epoxy di(meth)acrylate, 0.7 to 33.3% by weight of photopolymerizable (meth)acrylate, 25.7 to 33.3% by weight of photopolymerizable urethane oligomer having two or more (meth)acryloyl groups per molecule and an alpha-diketone as photoinitiator, a tertiary amine as photosensitizer and an onium salt as photoreaction accelerator. In addition the putty composition comprises fillers having a high light transmission. Examples of useful fillers are inorganic small hollow spherical fillers, e.g. glass bubbles, and ultrafine particles having a particle size of about 0.02 μm on average, such as ultrafine zinc oxide particles, ultrafine titanium dioxide particles and ultrafine barium sulphate particles. Fillers made of glass, for example, have the disadvantage that they can have an adverse effect on optimum sandability because of their relatively high level of hardness.

Furthermore, EP 983 801 describes a method for repairing damage to a coated surface of a vehicle comprising the steps of applying a UV curable putty raw material, UV curing the putty raw material, applying a UV curable primer surfacer and UV curing the primer surfacer. The putty raw material comprises 20-30% by weight of a UV polymerizing prepolymer, 15-30% by weight of a UV polymerizing monomer, 1-10% by weight of a UV polymerization initiator, 40-60% by weight of a pigment, 1-30% by weight of an ultraviolet transmitting material and/or ultraviolet absorbing material and 1-5% by weight of a non-reactive resin. The ultraviolet transmitting material and/or ultraviolet absorbing material is an organic or inorganic pigment from bluish purple to purple, whereas the putty comprises in addition conventional extender pigments such as calcium carbonate, barium sulphate, clay and talc.

However, the solutions proposed here were not able to solve the problems mentioned above to a completely satisfactory extent. There is therefore still a need for UV curable putty compositions, in particular for use in automotive repair coatings, which are applied at high film thicknesses, ensure absolutely complete curing right down to the bottom, and also have very good sandability. The putty layers are to adhere very well to the substrate and are also to have good adhesion in the edge zones of the coating and a good capacity for overpainting with other coating systems.

### SUMMARY OF THE INVENTION

This invention relates to putty compositions curable by means of high energy radiation, comprising

A) at least one compound capable of free-radical polymerization having at least one olefinically unsaturated group and

B) at least one filler, the at least one filler or a mixture of fillers having a particle size distribution such that at most 8% by volume, preferably at most 6% by volume, of the filler particles in relation to the total volume of fillers have a particle size of less than or equal to 1.9 μm.

This invention also relates to a process for multilayer coating of substrates, comprising:

I) applying a putty layer of a putty composition curable by means of high energy radiation to a substrate,

II) curing said putty layer by exposing it to high energy radiation and

III) applying at least one further coating layer of a further coating composition to the putty layer and curing the at least one further coating layer,

wherein the putty composition comprises

A) at least one compound capable of free-radical polymerization having at least one olefinically unsaturated group and

B) at least one filler, the at least one filler or a mixture of fillers having a particle size distribution such that at most 8% by volume, preferably at most 6% by volume, of the filler particles in relation to the total volume of fillers have a particle size of less than or equal to 1.9 μm.

Surprisingly, it has been found that when the putty compositions according to the invention are used at the conventional high film thicknesses, completely cured putty coatings can be obtained which adhere to the substrate very well and have very good sandability.

### BRIEF DESCRIPTION OF THE DRAWINGS

FIG. 1: is a graph of particle size distribution of Appyral® 15.

FIG. 2: is a graph particle size distribution of Appyral® 22.

FIG. 3: is a graph of particle size distribution of Min Talc® 97-45.

### DETAILED DESCRIPTION OF THE EMBODIMENTS

The present invention will be explained in more detail below:

It will be appreciated that certain features of the invention which are, for clarity, described above and below in the context of separate embodiments may also be provided in combination in a single embodiment. Conversely, various features of the invention that are, for brevity, described in the context of a single embodiment may also be provided separately or in any sub-combination. In addition, references in the singular may also include the plural (for example, “a” and “an” may refer to one, or one or more) unless the context specifically states otherwise.

The use of numerical values in the various ranges specified in this application, unless expressly indicated otherwise, are stated as approximations as though the minimum and maximum values within the stated ranges were both preceded by the word “about”. Thus, slight variations above and below the stated ranges can be used to achieve substantially the same results as values within the ranges. Moreover, in the disclosure of these ranges, a continuous range is intended, covering every value between the minimum and maximum values, including the minimum and maximum end points of the range.

High-energy radiation is intended to mean UV radiation and electron beam radiation.

A putty is intended to mean a pigmented, high-filler coating material which is applied for example to metal and is primarily used for the purpose of leveling those uneven areas in a substrate which are too large for correction using conventional primers or primer surfacers. Putties may be used both for leveling small uneven areas such as stone chips or scratches and also for covering relatively large uneven areas up to 1 cm deep (see Römpp Lexikon, Lacke und Druckfarben [Römpp Dictionary of Coatings and Printing Inks], page 531).

Fillers are substances comprising particles which are insoluble in the application medium, and are used in coating materials to increase volume, to obtain or improve certain technical properties and/or to influence optical properties (see Römpp Lexikon, Lacke und Druckfarben

[Römpp Dictionary of Coatings and Printing Inks], page 250; DIN 55943: 2001-10; 3.65).

Pigments are colorants in powder or platelet form which are insoluble in the surrounding medium (see Römpp Lexikon, Lacke und Druckfarben [Römpp Dictionary of Coatings and Printing Inks], page 451).

The term particle is intended to mean a delimitable unit of a pigment or filler. This may take any shape and have any structure (see DIN 55943: 2001-10; 3.136).

Particle size is a geometric measurement value for characterizing the spatial extent of a particle (see DIN 53 206, August 1972, 2). It may be indicated by various parameters.

Particle diameter: the diameter of a spherical particle or the characteristic dimension of a non-spherical but regularly delimited particle (see DIN 53 206, August 1972, 2.1).

Particle size distribution: the statistics of the particle sizes of a set of particles (see DIN 53 206, August 1972, 3). In practice, empirically determined particle size distributions may be presented for example in tabular form, in graphs in the form of a histogram, or in the form of a closed curve.

Thus, the particle size distribution of a filler may be characterized by a particle size distribution curve which shows the particle size along the x axis and the associated percentages of filler by weight or by volume along the y axis. Manufacturers of fillers typically specify what are known as the d98% values or d50% values. The d98% value, for example, also called the “upper section”, characterizes the percentages of filler by weight or by volume falling below a particular particle size. This means that a d98% value of for example 10 μm means that 98% by weight of the filler particles in relation to the total quantity of filler are smaller than 10 μm.

(Meth)acryloyl or (meth)acrylic are intended to mean acryloyl and/or methacryloyl or acrylic and/or methacrylic.

Unless stated otherwise, all molecular weights (both number and weight average molecular weight) referred to herein are determined by GPC (gel permeation chromatography) using polystyrene as the standard and tetrahydrofuran as the liquid phase.

The figures specified for particle size distribution in the present invention are based on determining the particle size and the particle size distribution using the Mastersizer 2000 measuring unit (Version 5.126) from Malvern Instruments Ltd., which operates by the laser diffraction method. Determination was carried out in accordance with the procedures laid down by the manufacturer of the measuring unit. It was based on ISO standard 13320-1 (Particle size analysis—Laser diffraction methods). As the particle size, the particle diameter was determined, assuming the particles being measured are spherical. The used technique measures the volume of the particle. This leads to the diameter of the sphere that has the same volume as the measured particle being reported as the particle size. Laser diffraction relies on the fact that particles passing through a laser beam will scatter light at an angle that is directly related to their size. Particle size distribution is calculated by comparing a sample's scattering pattern with an appropriate optical model. In the present invention Mie Theorie has been used as optical model. A standard refraction index of 1.520 has been used for the particles.

Preparation of the samples has been carried out with the dispersing module Hydro 2000S. Dispersant fluid was water. The samples have not been treated in a special way before and during measurement.

In principle, it is also possible to use other measurement methods or measuring units to analyse particle size, provided they give results comparable with the results obtained with the method used in the present invention. Also, results obtained with one method based on percent by weight of particles can be converted to percent by volume of particles, provided the density of particles is known.

First of all, the putty composition according to the invention will be described in more detail.

The putties according to the invention include 20 to 80% by weight, preferably 30 to 60% by weight, of compounds A) curable by UV radiation and 20 to 80% by weight, preferably 40 to 70% by weight, of fillers B), in each case in relation to the total putty composition. Preferably the putty compositions contain 80 to 95% by weight of components A) and B) in relation to the total putty composition.

The putty composition contains compounds curable by means of high energy radiation having at least one olefinically unsaturated group as component A). Compounds curable by means of high energy radiation that may be used as component A) comprise any conventional compounds which are radiation curable by free-radical polymerization. The compounds capable of free-radical polymerization have at least one olefinically unsaturated group, preferably 1 to 20, particularly preferably 1 to 10, most preferably 1 to 5 olefinically unsaturated groups per molecule. The compounds may have a C═C equivalent weight from 100 to 10,000, preferably from 200 to 5,000.

The person skilled in the art is aware of such compounds and is able to produce them in accordance with conventional methods to achieve the desired functionality.

The compounds capable of free-radical polymerization A) may comprise low-molecular compounds as well as prepolymers, such as polymers or oligomers, which comprise at least one polymerizable olefinically unsaturated group in the molecule. The polymerizable olefinically unsaturated groups may, for example, be present in the form of (meth)acryloyl, vinyl, allyl, maleate and/or fumarate groups. Particularly preferred olefinically unsaturated groups are (meth)acryloyl groups. The (meth)acryloyl groups may be present in combination with other olefinically unsaturated groups.

Examples of compounds A) are (meth)acryloyl-functional (meth)acrylic copolymers, (meth)acryloyl-functional epoxy resins, (meth)acryloyl-functional polyesters, (meth)acryloyl-functional polyethers, (meth)acryloyl-functional polyurethanes, urethane compounds, (meth)acryloyl-functional amino compounds, (meth)acryloyl-functional silicone resins, (meth)acryloyl-functional melamine resins, unsaturated polyurethanes or unsaturated polyesters with unsaturated groups other than (meth)acryloyl groups. Preferred are (meth)acryloyl-functional (meth)acrylic copolymers, (meth)acryloyl-functional polyesters, (meth)acryloyl-functional polyethers and (meth)acryloyl-functional polyurethanes and urethane compounds. The number average molecular weight (Mn) of these compounds is preferably in the range from 500 to 8,000. The compounds may be used individually or in a mixture.

The compounds capable of free-radical polymerization A) may comprise also UV curable monomeric reactive diluents. Reactive diluents are reactive, polymerizable liquid monomers that act as solvents in the system and participate in the crosslinking reaction of the coating composition.

UV curable reactive diluents are low molecular weight monomeric compounds capable of free-radical polymerization with a molecular mass for example below 500 g/mole. The reactive diluents may be mono-, di- or polyunsaturated monomers. Examples of monounsaturated reactive diluents are: (meth)acrylic acid and esters thereof, maleic acid and half esters thereof, vinyl acetate, vinyl ether, substituted vinyl ureas, styrene, vinyl toluene. Examples of diunsaturated reactive diluents are: di(meth)acrylates, such as alkylene glycol di(meth)acrylate, polyethylene glycol di(meth)acrylate, butane-1,3-diol di(meth)acrylate, vinyl(meth)acrylate, allyl(meth)acrylate, divinyl benzene, dipropylene glycol di(meth)acrylate, hexanediol di(meth)acrylate. Examples of polyunsaturated reactive diluents are: glycerol tri(meth)acrylate, trimethylol propane tri(meth)acrylate, pentaerythritol tri(meth)acrylate, pentaerythritol tetra(meth)acrylate. The reactive diluents may be used individually, or a mixture of a suitable combination of reactive diluents may be used.

Preferred reactive diluents are esters of alpha,beta-olefinically unsaturated monocarboxylic acids capable of free-radical polymerization having one olefinic double bond per molecule. These are esters of olefinically unsaturated monocarboxylic acids with aliphatic, cycloaliphatic or aromatic alcohols. Olefinically unsaturated monocarboxylic acids that may be considered are, for example, methacrylic acid, crotonic acid and isocrotonic acid. The alcohols in particular comprise aliphatic, cycloaliphatic or aromatic, monohydric branched or unbranched alcohols having 1-20 carbon atoms per molecule. Preferred are esters of (meth)acrylic acid. Examples of (meth)acrylic acid esters with aliphatic alcohols are methyl acrylate, ethyl acrylate, isopropyl acrylate, tert.-butyl acrylate, n-butyl acrylate, isobutyl acrylate, 2-ethylhexyl acrylate, lauryl acrylate, stearyl acrylate and the corresponding methacrylates. Examples of (meth)acrylic acid esters with cycloaliphatic alcohols are cyclohexyl acrylate, trimethylcyclohexyl acrylate, 4-tert.-butylcyclohexyl acrylate, isobornyl acrylate and the corresponding methacrylates. (Cyclo)aliphatic(meth)acrylates may also optionally be substituted. The substituents comprise, for example, one or more, for example up to three alkyl groups, in particular those having 1-4 carbon atoms. Examples of (meth)acrylates with aromatic alcohols are benzyl(meth)acrylates. (Meth)acrylic acid esters with cycloaliphatic alcohols, such as isobornyl(meth)acrylate, cyclohexyl(meth)acrylate and derivatives thereof are especially preferred as reactive diluents. The preferred reactive diluents may be used in combination with additional reactive diluents.

The putty composition can contain for example 40 to 70% by weight of polymeric and/or oligomeric prepolymers and 30 to 60% by weight of monomeric reactive diluents, based on the total amount of component A).

The putty compositions curable by means of high energy radiation may also contain, in addition to the components capable of free-radical polymerization by means of high energy radiation, further components, for example binders and/or reactive diluents that are chemically crosslinkable by an additional curing mechanism. Chemically crosslinking binders that may be used are, for example, any desired two-component binder system based on a hydroxy-functional component and an isocyanate-functional component, a hydroxy-functional component and an anhydride component, a polyamine component and an epoxide component and components which are able to react with each other by Michael reaction. The additional functional groups and the groups capable of free-radical polymerization may in this case be present in the same binder and/or in separate binders.

The putty composition according to the invention contains at least one filler (component B). The fillers to be used according to the invention are characterized by a specific particle size distribution. They are characterized by a particle size distribution such that at most 8% by volume, preferably at most 6% by volume, of the filler particles in relation to the total volume of fillers have a particle size of less than or equal to 1.9 μm. This means that they have a very low proportion of fine particles. The upper limit for the particle size in the particle size distribution is not critical and is within the order of magnitude conventionally typical of fillers. For example, at most 98% by volume of the filler particles in relation to the total volume of filler may have a particle size of less than or equal to 100 μm.

The fillers can be fillers conventionally used in coating compositions, especially putty compositions, which meet the requirements stated above. Examples of fillers to be used are carbonates, such as calcium carbonate and magnesium carbonate, sulphates, such as barium sulphate and calcium sulphate, silicates such as aluminium silicate, calcium silicate and talc (hydrated magnesium silicate), hydroxides, such as aluminium hydroxide and magnesium hydroxide and silicon dioxide.

Here, the conventionally obtainable fillers can be used if they meet the said restriction on the proportion of fine particles, wherein each of the fillers used has to meet the claimed particle size distribution or a combination of fillers has to meet the said restriction on the proportion of fine particles.

Of the fillers which meet the criteria mentioned above, those which have a refractive index of 1.5 to 1.8 and a Mohs hardness of about 1 to 5 are moreover preferred. Particularly preferred fillers are talc (hydrated magnesium silicate) and/or aluminium hydroxide, which must both meet alone or in combination with each other the requirements mentioned above of particle size and particle size distribution. Most preferred is a combination of talc and aluminium hydroxide.

The fillers may in principle be used individually or in combination with one another.

Where appropriate, up to 10% by volume, in relation to the total volume of filler particles, of further fillers or mixtures of fillers other than component B) may be used.

The putty compositions according to the invention contain one or more photoinitiators for the radical polymerization of components A). Suitable photoinitiators include, for example, those that absorb in the wavelength range from 190 to 600 nm. The photoinitiators may be present for example, in quantities of 0.1 to 10% by weight, preferably of 0.4 to 5% by weight, relative to the sum of binders capable of free-radical polymerization, reactive diluents and photoinitiators. Examples of suitable photoinitiators are benzoin and derivatives thereof, acetophenone and derivatives thereof, for example 2,2-diacetoxyacetophenone, benzophenone and derivatives thereof, thioxanthone and derivatives thereof, anthraquinone, 1-benzoylcyclohexanol, and organophosphorus compounds, such as acylphosphine oxides. The photoinitiators may be used individually or in combination.

The putty composition according to the invention may contain pigments. The pigments comprise conventional organic or inorganic pigments. In addition, corrosion protection pigments usable in the coatings industry may also be used. Examples of pigments are titanium dioxide, micronized titanium dioxide, iron oxide pigments, carbon black, azo pigments, and conventional pigments as used for preparing putty compositions. An example of a corrosion protection pigment is zinc phosphate.

The putty compositions may furthermore contain additives conventionally used in coating compositions, in particular in putty compositions. Examples of additives conventionally used in putty compositions are flow control agents, anti-settling agents and adhesion promoting agents. In this connection, it is advantageous to use in particular adhesion promoting agents based on phosphates which preferably also include unsaturated groups.

The additives are used in conventional quantities known to the person skilled in the art.

The putty compositions according to the invention may contain water and/or organic solvents. The compositions may, however, also take the form of 100% systems without organic solvents and water. The putty compositions may contain for example 0 to 10% by weight of water and/or organic solvents.

The putty compositions are produced in a conventional manner known to the person skilled in the art, for example by mixing in a dissolver.

Particularly preferred putty compositions comprise:

A) 30 to 60% by weight of at least one compound capable of free-radical curing A), the component A) being composed of

A1) 40 to 70% by weight of at least one oligomeric or polymeric prepolymer having at least one olefinically unsaturated group, preferably at least one (meth)acryloyl group,

A2) 20 to 40% by weight of at least one monomeric reactive thinner having one olefinically unsaturated group, preferably a (meth)acryloyl group, in the molecule, and

A3) 0-20% by weight of at least one monomeric reactive thinner having at least two, preferably 2 or 3, olefinically unsaturated groups, preferably (meth)acryloyl groups, in the molecule, wherein the % by weight of components A1), A2) and A3) add up to 100% by weight, and

B) 40 to 70% by weight of at least one filler as defined above, preferably including talc, aluminium hydroxide or mixtures thereof, wherein the % by weight of components A) and B) add up to 100% by weight.

Preferably the putty compositions contain 80 to 95% by weight of components A) and B) in relation to the total putty composition.

The present invention also relates to a process for multilayer coating using the putty composition described above.

According to this process, the putty layer is applied directly onto the substrate. Substrates can be e.g. metal substrates, such as iron, steel, galvanized steel, aluminium and zinc, or plastic substrates. Substrates are in particular automotive bodies or parts thereof. The putty can be applied to metal or plastic parts of the substrate, preferably the automotive body or parts thereof, or to already existing coatings. Application may be performed using known methods. The putties may be applied in conventional manner, applicable by brush, applicable with knife or sprayable. Depending on the type, they are applied in one or more layers. They are applied for example to give dry film thicknesses of 1 to 2 mm.

Once the putty composition has been applied to the substrate, the putty layer is exposed, optionally after a flash-off phase, to high energy radiation, preferably UV radiation. Usable UV radiation sources are those emitting in the wavelength range from 180 to 420 nm, in particular from 200 to 400 nm. It goes without saying that UV radiation sources usually emit also in the wavelength range of visible light or infrared radiation. If desired filters can be used to reduce or eliminate those emissions. Examples of UV radiation sources are optionally doped high, medium and low pressure mercury vapour emitters, gas discharge tubes, such as low pressure xenon lamps, unpulsed UV lasers, and UV point source emitters, such as UV emitting diodes and black light tubes.

In addition to these continuously operating UV radiation sources, it is, however, also possible to use discontinuous UV radiation sources, for example pulsed UV lasers or “high energy flash installations” (known as UV flash lamps for short). The UV flash lamps may contain a plurality of flash tubes, for example, quartz tubes filled with inert gas such as xenon. The irradiation time with UV radiation when UV flash lamps are used as the UV radiation source may be, for example, in the range from 1 millisecond to 400 seconds, preferably from 4 to 160 seconds, depending on the number of flash discharges selected. The flashes may be triggered for example about every second. Curing may take place for example by means of 1 to 40 successive flash discharges. If continuous UV radiation sources are used, the irradiation time may be, for example, in the range from a few seconds to about 5 minutes, preferably less than 5 minutes.

Moreover, UV-A lamps, i.e. UV radiation sources which substantially emit UV-A radiation, can be used to cure the putty compositions of the present invention. A UV radiation source which substantially emits UV-A radiation is a UV radiation source which emits UV radiation having a UV-B:UV-A ratio of less than 1, preferably having a UV-B:UV-A ratio of less than 0.5, particularly preferably having a UV-B:UV-A ratio of less than 0.2, and which emits substantially no UV-C radiation.

The required spectral output (UV-B:UV-A ratio, substantially no UV-C radiation) of the UV radiation source can be generated by using a UV radiation lamp directly emitting UV radiation of the required wavelength in the required ratio or by using a conventional UV radiation source in combination with appropriate filters. For example, a particular filter can be used to generate UV radiation of a wavelength of 280-440 nm. The spectral output of a given radiation source can be measured with an energy dispersive spectrograph comprising a monochromator and light detector whereof the sensitivity is known at the relevant wavelengths. The ratio of UV-B:UV-A can be determined by integrating the intensities of spectral output in the respective wavelength ranges. Appropriate measuring instruments are commercially available and well known to a person skilled in the field of UV technology.

Suitable UV-A lamps are commercially available. An example of a suitable UV-A lamp is the lamp “UVA hand 250” from Dr. Hönle GmbH.

In principle the distance between the UV radiation sources and the substrate surface to be irradiated may be for example 2 to 60 cm. Usual radiation times are for example in the range of 1 to 5 minutes.

If the putty compositions contain binders which cure by an additional crosslinking mechanism, the coatings may be left after the irradiation operation to cure completely at room temperature, for example for 16 to 24 hours. It is also possible to perform complete curing at higher temperatures of, for example, 30 to 130° C., preferably of 40 to 80° C. Complete curing may take place by conventional methods, for example in a heated booth or by means of IR radiation. Depending upon the curing temperature, curing times of for example 1 to 60 minutes are possible. Thermal curing may, of course, also be performed before the irradiation phase or before and after the irradiation phase.

Once the putty layer has been cured by means of high energy radiation, in accordance with the process according to the invention the putty layer is overpainted with at least one further coating layer. Usually the putty layer is overpainted with a primer and/or primer surfacer and a top coat.

Conventional waterborne or solvent-borne primer and primer surfacers can be used, as known in the automotive coating and automotive repair coating industries.

The layer of a primer and/or primer surfacer is then overpainted with a top coat. The top coat layer may comprise a layer of a pigmented coating composition (base coat composition, which gives the substrate to be coated a desired colour and/or effect) and a layer of a transparent clear coat composition. Alternatively the top coat layer may comprise a layer of a pigmented single stage coating composition, which gives the substrate to be coated a desired colour and/or effect. No particular restrictions apply with regard to the base coat, clear coat and pigmented single stage top coat composition that are to be used at this point.

Any solvent-borne or waterborne base coat composition known to the person skilled in the art and conventional in automotive coating, in particular in automotive repair coating, is suitable. The pigmented base coat compositions and the single stage top coat composition contain colour-imparting and/or special effect-imparting pigments, which give the coating a desired colour and/or effect.

Curing of the coating layers applied to the putty layer may proceed at room temperature or be accelerated at, for example, 40-80° C. or higher temperatures up to, for example, 130° C. Coating compositions curable by means of UV radiation are also suitable as base coat, clear coat and/or single stage top coat compositions for preparing the top coat layer.

The process according to the invention can particularly be used in vehicle coatings, e.g. in car and transportation vehicle coatings. Particularly advantageously, it can be used in repair coatings of vehicle bodies and parts thereof for repairing damage to the coated surface.

The putty compositions according to the invention give coatings with very good adhesion to various metal substrates, as well as plastic substrates and already existing coatings, and unproblematic adhesion even in the edge zones of the coating, with a relatively small film thickness. Insufficient adhesion, in particular in the edge zones of the coating, can result in a mark in the corresponding places that shows right through to the topcoat layer. The coatings have an acceptable hardness and very good sandability. There is no clogging of the sandpaper, or only to a very limited extent. The cured putty layers can be overpainted with other coating layers to give good quality.

The following Examples are intended to illustrate the invention in greater detail.

### EXAMPLES

### Example 1

Preparation of a Putty According to the Invention

The following components were prepared in conventional manner, using a dissolver, to give a putty:

24.48 parts by weight of a commercially available UV curable urethane (meth)acrylate (Roskydal UA LS 2258; Bayer AG),

10.50 parts by weight of isobornyl acrylate (UCB),

0.21 parts by weight of a commercially available flow control agent (Byk 410; Byk Chemie),

5.28 parts by weight of a commercially available anti-settling agent (Antiterra U; Byk Chemie),

27.18 parts by weight of a commercially available filler based on hydrated magnesium silicate (Min Talc (97-45x); Mines Minerals),

27.18 parts by weight of a commercially available filler based on aluminium hydroxide (Apyral 15; Nabaltec),

0.92 parts by weight of a commercially available photoinitiator (Irgacure 819; Ciba),

0.62 parts by weight of a commercially available photoinitiator (Darocure 1173),

3.22 parts by weight of a commercially available flow control agent (Bentone 38; Elementis),

1.49 parts by weight of a commercially available unsaturated phosphoric acid esters (Ebecryl 171; UCB)

### Example 2

Preparation of a Comparison Putty 1

A putty like that in Example 1 was prepared except that instead of the filler Apyral 15 27.18 parts by weight of a filler with a larger proportion of fine particles (Apyral 22; Nabaltec) was used.

### Example 3

Preparation of a Comparison Putty 2

A putty like that in Example 1 was prepared except that instead of the fillers Apyral 15 and Min Talc (97-45x) 54.36 parts by weight of a filler with a larger proportion of fine particles (Apyral 22; Nabaltec) was used.

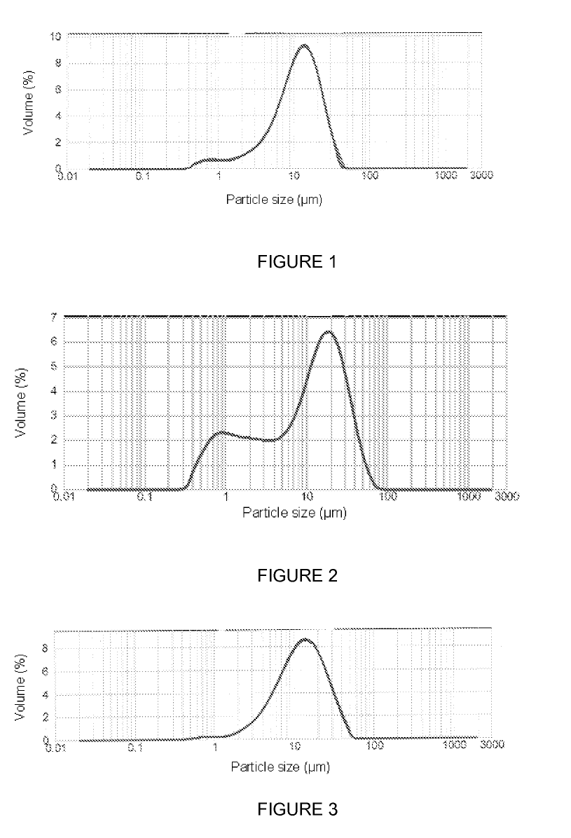

The particle size distributions of the fillers used (of Apyral 15, of Apyral 22, of Min Talc (97-45x)) are represented below in FIGS. 1 to 3 in form of a distribution curve. The particle size distribution was determined using the Mastersizer 2000 measuring unit (Version 5.126) from Malvern Instruments Ltd. under the conditions specified by the manufacturer and as explained in the description of the present invention.

The following parameters have been determined from the particle size distribution parameters (<=means less than and equal to):

| | Particle size | % by volume of particles |
|---|---|---|
| Appyral 15 | <=1.660 μm | 5.44 |
| | <=1.905 μm | 6.18 |
| Min Talc 97-45x | <=1.660 μm | 1.45 |
| | <=1.905 μm | 1.85 |
| Appyral 22 | <=1.660 μm | 18.40 |
| | <=1.905 μm | 20.30 |

The percent by volume of particles in the respective particle size range for the mixtures of fillers (Mixture of Appyral 15+Min Talc (97-45x) (Ex. 1) and Mixture of Appyral 22+Min Talc (97-45x) (Ex. 2)) have been calculated on basis of the figures of the individual fillers and the ratio of the individual fillers in the mixture:

Mixture of Appyral 15+Min Talc 97-45 (ratio by weight of the fillers=50:50, ratio by volume of the fillers=52.943:47.057):

Particle size<=1.660 μm: 3.56% by volume of particle mixture

Particle size<=1.905 μm: 4.14% by volume of particle mixture

Mixture of Appyral 22+Min Talc (ratio by weight of the fillers=50:50, ratio by volume of the fillers=52.943:47.057):

Particle size<=1.660 μm: 10.42% by volume of particle mixture

Particle size<=1.905 μm: 11.62% by volume of particle mixture

### APPLICATION EXAMPLES

The putty compositions prepared in accordance with Example 1 and Comparison Examples 2 and 3 were applied to a metal substrate using a putty knife to give a dry film thickness of about 2 mm.

Directly after the application, each was subjected to radiation using a UV flash lamp (UV Flash Dry 15/700; Visit). Radiation was carried out with 20 flashes over about 40 seconds.

The putty layers obtained in this way were then tested for hardness and sandability. The results of these tests are presented below:

| | Example 1 | Example 2 | Example 3 |
|---|---|---|---|
| Hardness at a depth of 1.5 mm (1) | 8 | 6 | 4 |
| Sandability at a depth of 1.5 mm (2) | OK | not OK | not OK |

The results show that after UV radiation the putty prepared in accordance with the invention has a significantly better hardness at a depth of 1.5 mm and is also sandable without problems and without clogging up the sandpaper. By contrast, the comparison putties have a completely inadequate level of hardness at depth, and when they are sanded rapid clogging of the sandpaper is observed.

(1) Determination of the so-called fingernail hardness by the fingernail test.

The test was carried out at a depth of 1.5 mm, for which purpose a wedge shape was first ground into the putty layer.

The following scale was used in determining the result:

10—not possible for the fingernail to penetrate

8—very slight penetration with the fingernail possible

6—slight penetration with the fingernail possible

4—medium level of penetration with the fingernail possible

2—considerable level of penetration with the fingernail possible

0—very pronounced penetration with the fingernail possible

(2) An eccentric sanding operation was carried out using sandpaper P 120 at a depth of 1.5 mm, for which purpose the putty layer was first of all removed to leave a film thickness of 0.5 mm. In the assessment, OK means good sandability with no clogging of the sandpaper, and not OK means the sandability was not good and the sandpaper clogged up rapidly.

1. Putty composition curable by means of high energy radiation, comprising
A) at least one compound capable of free-radical polymerization having at least one olefinic unsaturated group and
B) at least one filler, the at least one filler or a mixture of fillers having a particle size distribution such that at most 8% by volume of the filler particles in relation to the total volume of fillers have a particle size of less than or equal to 1.9 μm.

2. The putty composition according to claim 1, wherein the at least one filler or a mixture of fillers having a particle size distribution such that at most 6% by volume of the filler particles in relation to the total volume of fillers have a particle size of less than or equal to 1.9 μm.

3. The putty composition according to claim 1, comprising 20 bis 80% by weight of component A) and 20 bis 80% by weight of component B), based on the total amount of the putty composition.

4. The putty composition according to claim 3, comprising 30 bis 60% by weight of component A) and 40 bis 70% by weight of component B), based on the total amount of the putty composition.

5. The putty composition according to claim 1, wherein the at least one filler B) has a refraction index of 1.5 to 1.8.

6. The putty composition according to claim 1, wherein the at least one filler B) has a Mohs hardness of 1 to 5.

7. The putty composition according to claim 1, wherein at most 98% by volume of the filler particles in relation to the total volume of filler have a particle size of less than or equal to 100 μm.

8. The putty composition according to claim 1, wherein the at least one filler B) is selected from a group consisting of talc, aluminium hydroxide and mixtures thereof.

9. Process for multilayer coating of substrates comprising:
I) applying a putty layer of a putty composition according claim 1 to a substrate,
II) curing said putty layer by exposing it to high energy radiation and
III) applying at least one further coating layer of a further coating composition to the putty layer and curing the at least one further coating layer.

10. The process according to claim 9 wherein the at least one further coating composition comprises a primer surfacer composition and a top coating composition.

11. The process according to claim 10, wherein the top coating composition comprises a color- and/or special effect imparting base coat coating composition and a transparent clear coat coating composition applied over the base coat coating composition.

12. The process according to claim 10, wherein the top coating composition comprises a pigmented one-layer top coating composition.

13. The process according to claim 9, wherein the substrate is a vehicle body or part thereof.

14. The process according to claim 13, wherein it is a process for repair coating vehicle bodies or parts thereof.
